(19) United States
(12) Patent Application Publication
(10) Pub. No.: US 2024/0012632 A1
(43) Pub. Date: Jan. 11, 2024

(54) COORDINATING UPDATES TO AN AGENT PLATFORM APPLIANCE IN WHICH AGENTS OF CLOUD SERVICES ARE DEPLOYED

(71) Applicant: VMWARE, INC., Palo Alto, CA (US)

(72) Inventors: CHAITANYA DESHMUKH, Santa Clara, CA (US); Avinash Venkatesh BHAT, Bangalore (IN); Praveen TIRUMANYAM, Bangalore (IN); Fnu YASHU, Sunnyvale, CA (US); Prateek GUPTA, San Francisco, CA (US)

(21) Appl. No.: 17/940,063

(22) Filed: Sep. 8, 2022

(30) Foreign Application Priority Data
Jul. 8, 2022 (IN) 202241039355

(51) Int. Cl. G06F 8/65; G06F 8/71

(52) U.S. Cl. CPC G06F 8/65; G06F 8/71

(57) ABSTRACT

A cloud service for managing an agent platform appliance is configured to issue commands to an agent platform management agent deployed on the agent platform appliance to upgrade the agent platform appliance to a desired version. Upon receipt of this command, the agent platform management agent carries out a method of updating the agent platform appliance, which includes: determining that a current version of the agent platform appliance does not match the desired version, determining connectivity to a repository that stores bits for updating the agent platform appliance to the desired version, requesting a first agent to perform a first pre-update check and a second agent to perform a second pre-update check, and after the first pre-update check and the second pre-update check have passed, requesting an appliance management service running on the agent platform appliance to perform an update of the agent platform appliance to the desired version.

### RELATED APPLICATIONS

Benefit is claimed under 35 U.S.C. 119(a)-(d) to Foreign Application Serial No. 202241039355 filed in India entitled “COORDINATING UPDATES TO AN AGENT PLATFORM APPLIANCE IN WHICH AGENTS OF CLOUD SERVICES ARE DEPLOYED”, on Jul. 8, 2022, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services” are delivered to the SDDCs through agents of the cloud services that are running in an appliance (referred to herein as a “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the respective agents of the cloud services.

In the embodiments, a cloud service for managing the agent platform appliance is also provided in the cloud platform. This cloud service is configured to issue commands to an agent platform management agent deployed on the agent platform appliance to upgrade the agent platform appliance to a desired version. Upon receipt of this command, the agent platform management agent carries out a method of updating the agent platform appliance, which includes: determining that a current version of the agent platform appliance does not match the desired version, determining connectivity to a repository that stores bits for updating the agent platform to the desired version, requesting a first agent to perform a first pre-update check and a second agent to perform a second pre-update check, and after the first pre-update check and the second pre-update check have passed, requesting an appliance management service running on the agent platform appliance to perform an update of the agent platform appliance to the desired version.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 illustrates components of the cloud platform and components of an agent platform appliance that are involved in updating the agent platform appliance to a desired version.

FIG. 3 is a diagram that depicts a sequence of steps that are carried out by the components of the cloud platform and the components of the agent platform appliance to update the agent platform appliance to the desired version.

FIG. 4 is a flow diagram of a method carried out by an agent platform management agent deployed on the agent platform appliance to perform pre-update checks on the agent platform appliance.

### DETAILED DESCRIPTION

In the embodiments, a cloud service for managing updates to the agent platform appliance is provided. This cloud service communicates with an agent platform management agent deployed on the agent platform appliance and issues commands to the agent platform management agent to update the agent platform appliance to a desired version. Upon receipt of this command, the agent platform management agent compares a desired version to which the agent platform appliance is to be updated against a current version of the agent platform appliance. Then, upon determining that the current version does not match the desired version, the agent platform management agent performs pre-update checks to confirm that none of the agents or SDDC management appliances are in the process of being updated. If none of the agents or SDDC management appliances are in the process of being updated, the agent platform management agent issues a request to an appliance management service running on the agent platform appliance to perform an update of the agent platform appliance to the desired version.

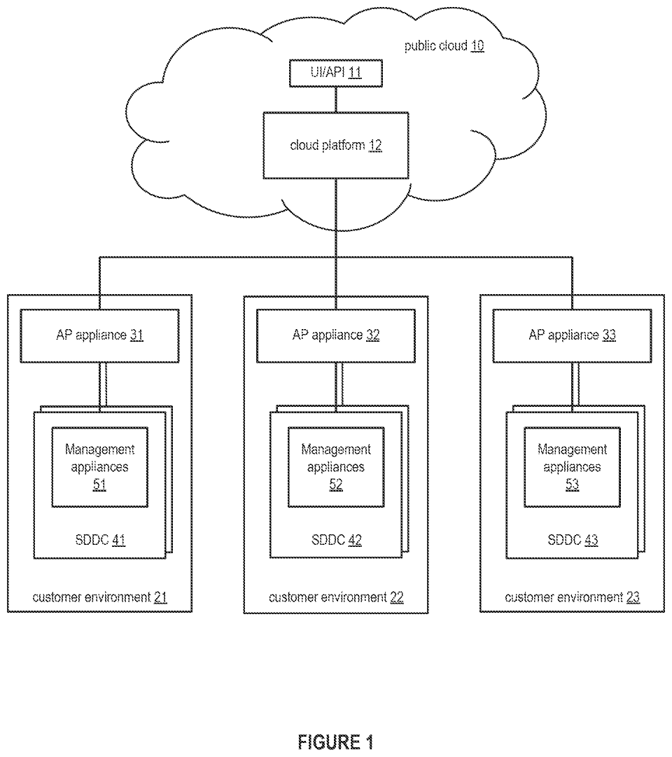

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) of cloud platform 12 is depicted in FIG. 1 as UI/API 11.

A plurality of SDDCs is depicted in FIG. 1 in each of customer environment 21, customer environment 22, and customer environment 23. In each customer environment, the SDDCs are managed by respective management appliances, which include a virtual infrastructure management (VIM) server (e.g., the VMware vCenter Server® appliance) for overall management of the virtual infrastructure, and a network management server (e.g., the VMware NSX® appliance) for management of the virtual networks. For example, SDDC 41 of the first customer is managed by management appliances 51, SDDC 42 of the second customer by management appliances 52, and SDDC 43 of the third customer by management appliances 53.

The management appliances in each customer environment communicate with an agent platform (AP) appliance, which hosts agents that communicate with cloud platform 12 to deliver cloud services to the corresponding customer environment. For example, management appliances 51 in customer environment 21 communicate with AP appliance 31. Similarly, management appliances 52 in customer environment 22 communicate with AP appliance 32, and management appliances 53 in customer environment 23 communicate with AP appliance 33.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments, each of the agent platform appliances and the management appliances is a VM instantiated on one or more physical host computers having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. In some embodiments, any of the agent platform appliances and the management appliances may be implemented as a physical host computer having the conventional hardware platform described above.

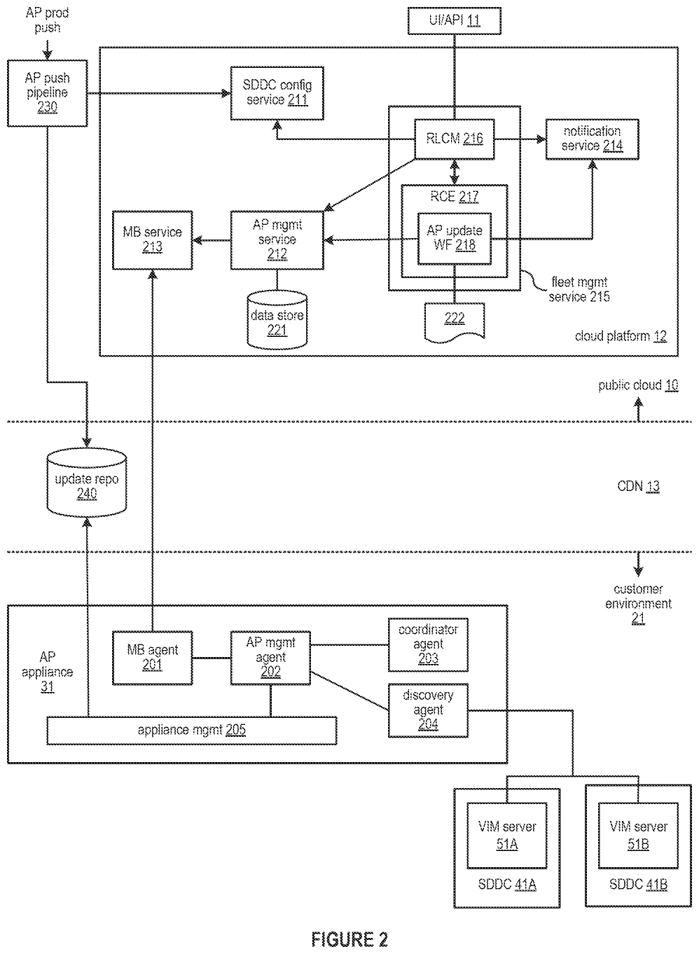

FIG. 2 illustrates components of cloud platform 12 and AP appliance 31 that are involved in updating AP appliance 31 to a desired version. In FIG. 2, AP appliance 31 of customer environment 21 is selected for illustration. The description given herein for AP appliance 31 also apply to AP appliances of other customer environments, including AP appliance 32 and AP appliance 33.

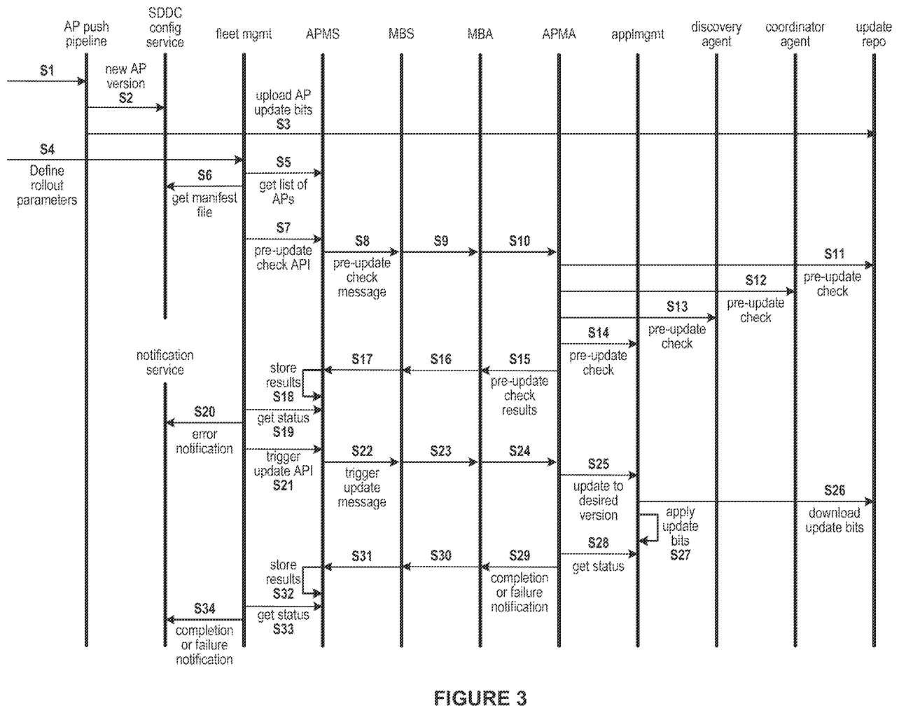

FIG. 3 is a diagram that depicts a sequence of steps that are carried out by the components of the cloud platform and the components of the AP appliance to update the AP appliance to the desired version. In the example given herein, the steps carried out by one AP appliance, namely AP appliance 31, are depicted for simplicity. It should be understood that steps similar to the ones carried out by one AP appliance 31 are also carried out by other AP appliances that are being updated. The sequence of steps depicted in FIG. 3 is carried out after AP appliance 31 has been deployed and registered in customer environment 21 to host agents of cloud services running in cloud platform 12, including all of the agents shown in FIG. 2.

Updates to the AP appliances for each tenant may be rolled out for deployment into the production environment of that tenant when build bundles for updating the AP appliances to a new version have been developed and successfully tested and pushed into a AP push pipeline 230 at step S1. In response, AP push pipeline 230 generates an ID of the new version (e.g., a new version number) and an associated manifest file which identifies the different build bundles containing the production-ready update bits of the new version, and at step S2 sends the ID of the new version and the associated manifest file to SDDC configuration service 211, which stores the ID of the new version and the associated manifest file as a key-value pair in a key-value database. AP push pipeline 230 also uploads the update bits of the different build bundles of the new version to an update repository 240 (step S3). In one embodiment, update repository 240 is deployed in a content delivery network (CDN) 13 and is accessed using its URL by AP push pipeline 230 when uploading the update bits and by appliance management service 205 running on AP appliance 31 when downloading the update bits. As used herein, a content delivery network is a distributed group of servers that work together to delivery content over the Internet.

In the embodiments, AP management service 212 is responsible for triggering pre-update checks on designated AP appliances, triggering updates to designated AP appliances, monitoring the pre-update check and update processes, and creating alert notifications on success or failure. AP management service 212 also maintains an inventory of the AP appliances in data store 221, and stores the following inventory information for each AP appliance: latest pre-update check results, latest update results, version number, organization name, health status, region, and others, such as IDs of management appliances 51 that have been registered for communication with their respective discovery agents. In one embodiment, upon registration of a management server, the discovery agent notifies AP management agent 202 of the ID of the registered management server and AP management agent in turn notifies AP management service 212, which stores such information in data store 221 in association with an ID of the AP appliance. AP management service 212 exposes various application programming interfaces (APIs) which are called by other services to: (1) get the inventory of AP appliances and information about the AP appliances; (2) trigger updates to the AP appliances specified in the call to a desired version; (3) get status of an update to a AP appliance specified in the call; (4) run pre-update checks on the AP appliances specified in the call; and (5) get pre-update check results for a AP appliance specified in the call.

Fleet management service 215 schedules the updates to the AP appliances to a desired version one group at a time and in different waves (also referred to as stages or phases) according to rollout parameters defined by the customer at step S4 interfacing with rollout lifecycle manager (RLCM) 216 of fleet management service 215 through UI/API 11, The rollout parameters may be some customer preference (e.g., not to update all the AP appliances of the customer's organization in the same wave), or may be constraints based on region or some other factors such as site reliability engineering (SRE) availability. In general, a scheduled rollout has multiple waves and each wave can specify multiple AP appliances to be updated, and the manifest file which identifies the different build bundles containing the production-ready update bits of the desired version.

To create the rollouts, RLCM 216 at step S5 calls the API of AP management service 212 to acquire the list of AP appliances of the tenant and their inventory information, and filters the list of AP appliances according to the rollout parameters. Then, RLCM 216 at step S6 calls a get API of SDDC configuration service 211 to acquire the manifest file associated with the desired version of the AP appliance. Once the rollouts are created by RLCM 216, release coordination engine (RCE) 217 executes a AP update workflow 218 to execute on the rollouts.

Prior to scheduling the updates for the AP appliances designated in the rollouts, RCE 217 at step S7 calls the API of AP management service 212 to run pre-update checks on the AP appliances. This API specifies the desired version of the AP appliance update. The pre-update checks are performed so that any issues with the AP appliances can be remediated prior to performing the updates to the desired version.

In response to the API call to perform pre-update checks, AP management service 212 generates a pre-update check message for each of the AP appliances specified in the API call. To simply the subsequent description, it is assumed that one of the AP appliances specified in the API call is AP appliance 31 and the functionality of the agents deployed on AP appliance 31 will be described. The agents deployed on other AP appliances specified in the API call will have the same functionality as the agents deployed on AP appliance 31.

At step S8, the message is sent to message broker (MB) service 213 which at step S9 transmits the message to a message broker (MB) agent 201 of AP appliance 31 upon receiving a request to exchange messages from MB agent 201. MB agent 201 is responsible for routing the messages from MB service 213 and at step S10 routes the pre-update check messages to AP management agent 202 of AP appliance 31, which is responsible for carrying out the pre-update checks S11-S14 to confirm that: (1) AP appliance 31 is able to reach update repository 240; (2) AP appliance 31 is not already at the desired version and is not in the process of being updated to the desired version; (3) AP appliance 31 has sufficient computational resources to complete the update; (4) none of management appliances 51 (to which cloud platform 12 delivers cloud services through AP appliance 31) are in the process of being updated; and (5) none of the agents deployed on AP appliance 31 are in the process of being updated.

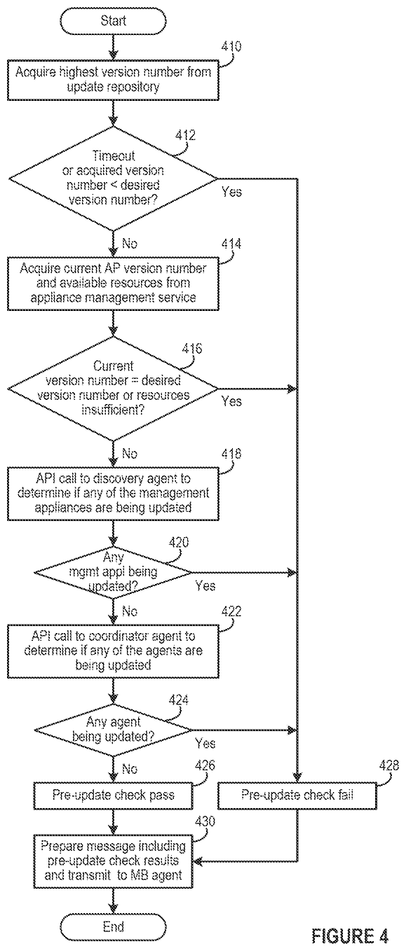

FIG. 4 is a flow diagram of a method carried out by AP management agent 202 to perform pre-update checks S11-S14 on AP appliance 31. Steps 410 and 412 of FIG. 4 correspond to step S11. Steps 414 and 416 of FIG. 4 correspond to step S14. Steps 418 and 420 of FIG. 4 correspond to step S13. Steps 422 and 424 of FIG. 4 correspond to step S12.

At step 410, AP management agent 202 issues an HTTP get request to update repository 240 to acquire the highest version number of the updates bits that are stored in update repository 240. If the request times out as determined at step 412, AP management agent 202 determines the pre-update check to have failed (step 428). The reason for failing the pre-update check here is that there is no connectivity to update repository 240. In addition, if the highest version number acquired from update repository 240 is less than the desired version number as determined at step 412, AP management agent 202 determines the pre-update check to have failed (step 428). The reason for failing the pre-update check here is that update repository 240 does not have the update bits that are necessary to support the update of AP appliance 31 to the desired version.

At step 414, AP management agent 202 calls an API of appliance management service 205 to acquire the current version number and information on computational resources (e.g., CPU and memory) that are current available on AP appliance 31. If the current version number equals the desired version number as determined at step 416, AP management agent 202 determines the pre-update check to have failed (step 428). The reason for failing the pre-update check here is that the update is not necessary. In addition, if the computational resources that are current available on AP appliance 31 is less than what is required to support the update of AP appliance 31 as determined at step 416, AP management agent 202 determines the pre-update check to have failed (step 428). The reason for failing the pre-update check here is that AP appliance 31 does not have sufficient computational resources to support the update of AP appliance 31 to the desired version.

Discovery agent 204 is configured to manage communications with management appliances 51 of SDDC 41 (e.g., virtual infrastructure management (VIM) server appliance 51A of SDDC 41A and VIM server appliance 51B of SDDC 41B). At step 418, AP management agent 202 calls an API of discovery agent 204 to determine if any of management appliances 51 are in the process of being updated. If so, as determined at step 420, AP management agent 202 determines the pre-update check to have failed (step 428). The reason for failing the pre-update check here is that the update may interfere with the process of updating management appliances 51.

Coordinator agent 203 is configured to manage the lifecycle of agents deployed on AP appliance 31. At step 422, AP management agent 202 calls an API of coordinator agent 203 to determine if any of the agents are in the process of being updated. If so, as determined at step 424, AP management agent 202 determines the pre-update check to have failed (step 428). The reason for failing the pre-update check here is that the update may interfere with the process of updating the agents.

If all of the determinations at steps 412, 416, 420, and 424 are “no,” AP management agent 202 determines the pre-update check to have passed (step 426). Step 430 of FIG. 4 corresponds to step S15 of FIG. 3. After performing the pre-update checks, AP management agent 202 prepares a message that identifies the current version of the AP appliance and indicates either “update-ready” (if the pre-update check passed) or “update-not-ready” (if the pre-update check failed). The message is sent to MB agent 201 at step S15, which transmits the message to MB service 213 at step S16 during its message exchange with MB service 213.

To monitor the status of the pre-update checks and the status of updates, AP management service 212 calls an API of MB service 213 to subscribe to update events, which include messages containing either pre-update check results or update results. This subscribing step is not shown in FIG. 3 but is carried out for example when AP management service 212 is deployed on AP appliance 31. Thus, when MB service 213 receives the update event that includes the pre-update check results from MB agent 201, MB service 213 transmits the update event to AP management service 212 at step S17. At step S18, AP management service 212 updates the inventory information in data store 221 based on the message contents.

After issuing the API call to run pre-update checks on a list of AP appliances, RCE 217 periodically issues API calls to get the status of the pre-update checks. The API call at step S19 represents the “get status” API call made after AP management service 212 receives the pre-update check results. If any of the pre-update checks fail, RCE 217 triggers alerts to SRE and a proper error notification is provided through notification service 214 at step S20. In situations where the failure is deemed temporary, e.g., pre-update checks (3), (4), and (5) described above, RLCM 216 may include the ID of this AP appliance in a list of AP appliances to be updated in a subsequent wave.

For the AP appliances that pass the pre-update checks, RCE 217 at step S21 calls the API of AP management service 212 to trigger the updates on such AP appliances to the desired version. The API call includes desired AP appliance version number as well as the manifest file which identifies the different build bundles containing the production-ready update bits of the desired version.

In response to the API to trigger the updates, AP management service 212 prepares a trigger update message that specifies the desired version number and the manifest file, and sends the trigger update message to MB service 213 at step S22 for delivery to each of the AP appliances specified in the API call.

To simply the subsequent description, it is assumed that one of the AP appliances specified in the API call is AP appliance 31 and the functionality of the agents deployed on AP appliance 31 will be described. The agents deployed on other AP appliances specified in the API call will have the same functionality as the agents deployed on AP appliance 31.

The trigger update message is routed through MB service 213 at step S23 and MB agent 201 at step S24 to AP management agent 202. Upon receiving the trigger update message from MB agent 201, AP management agent 202 at step S25 calls an API of appliance management service 205 to perform the update of AP appliance 31 to the desired version using the information contained in the manifest file. In response, appliance management service 205 downloads the bits of the build bundles identified in the manifest file from update repository 240 at step S26 and applies the update bits to AP appliance 31 to update AP appliance 31 to the desired version at step S27. AP management agent 202 monitors the progress of the update being carried out by appliance management service 205 by periodically polling for the status of the update. Step S28 represents the “get status” request made after appliance management service 205 has completed applying the update bits to AP appliance 31. When the update has completed or failed, AP management agent 202 at step S29 sends a notification of completion or failure to MB agent 201, which sends it to MB service 213 at step S30.

AP management service 212, having subscribed to update events, receives the notification of completion or failure from MB service 213 at step S31. AP management service 212 persists the update status in data store 221 for update visibility (step S32). In case the update passed on a AP appliance, the inventory information for that AP appliance in data store 221 is updated to also indicate that the AP appliance is at the desired version. In case the update failed on a AP appliance or there is no update progress reported by a AP appliance within a given time, the inventory information for that AP appliance in data store 221 is updated to indicate that the update has failed.

After issuing the trigger update API, RCE 217 periodically issues API calls to AP management service 212 to get the status of the update. The API call at step S33 represents the “get status” API call made after AP management service 212 receives the update results. In response, AP management service 212 accesses data store 221 to retrieve the update results and returns the update results to RCE 217. For the updates that passed, a notification of completion is provided through notification service 214 at step S34. Also, if any of the updates failed, RCE 217 triggers alerts to SRE and a notification of failure is provided through notification service 214 at step S34.

Notification service 214 also provides customer notifications when updates to the agent platform appliances have been scheduled. Such notification is triggered by RLCM 216 when RLCM 216 creates the rollouts for execution by AP update workflow 218 of RCE 217. In addition, as described above, notification service 214 provides notifications about success or failures of the scheduled updates upon receipt of this information from RCE 217.

When the reason for update failure is identified and a fix is validated, auto-remediation or manual remediation may be carried out. Auto-remediation may be performed by creating a remediation script 222 and executing remediation script 222 on the AP appliances that failed. Manual remediation may be performed by establishing a secure shell session and carrying out the remediation steps through the secure shell session. After remediation, RLCM 216 may include such AP appliances in a list of AP appliances to be updated in a subsequent wave. If the issue cannot be resolved, notification is provided through notification service 214 that an update of the AP appliance to the desired version is not possible and will require redeployment of the AP appliance.

In the embodiments, the AP management agents deployed on the AP appliances each issue API calls periodically to AP management service 212. If there is connectivity between cloud platform 12 and the AP appliance, AP management service 212 in response to the API call records the connection status (“1” for connected) in data store 221, and sends a response back to the AP management agent. Over time, AP management service 212 compiles the connection status of all the AP appliances based on the API calls from the AP management agents deployed on the AP appliances. If the connection status of any AP appliance is “0” (which is the initial value of the connection status representing the “disconnected” connection status) for more than a threshold number of days (e.g., 15 days), the AP appliance is determined to be stale and AP management service 212 unregisters the AP appliance.

In some embodiments, if after issuing API calls, a AP management agent does not receive any return response from AP management service 212 in response to a maximum number of consecutive API calls (e.g., 3), the AP management agent checks update repository 240 to acquire the highest version of the update bits stored therein. If this highest version is greater than the current version of the AP management appliance, the AP management agent executes the pre-update check (steps S11-S14 of FIG. 3) and, if the pre-update check passes, executes steps S25-S27 of FIG. 3 to update the AP appliance to the new version (i.e., the highest version stored in update repository 240). Accordingly, in some embodiments, the instruction to update When the connection to cloud platform 12 is re-established and the AP management agent receives a return response from AP management service 212, the AP management agent executes step S29 of FIG. 3 to send a notification of update completion or failure to AP management service 212.

In one embodiment, each of the cloud services is a microservice that is implemented as one or more container images executed on a virtual infrastructure of public cloud 10. Similarly, each of the agents and services deployed on the AP appliances is a microservice that is implemented as one or more container images executing in the AP appliances.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of updating an agent platform appliance in a customer environment on which cloud service agents are deployed to deliver cloud services to management appliances of a software-defined data center provisioned in the customer environment, said method comprising:
in response to an instruction to update the agent platform appliance to a desired version, (i) determining that a current version of the agent platform appliance does not match the desired version, (ii) determining connectivity to a repository that stores bits for updating the agent platform appliance to the desired version, and (iii) requesting a first agent of the cloud service agents to perform a first pre-update check and a second agent of the cloud service agents to perform a second pre-update check; and
after the first pre-update check and the second pre-update check have passed, requesting an appliance management service running on the agent platform appliance to perform an update of the agent platform appliance to the desired version.

2. The method of claim 1, further comprising:
in response to the instruction to update the agent platform appliance to the desired version, determining that the agent platform appliance has sufficient computational resources to update the agent platform appliance to the desired version.

3. The method of claim 1, wherein the appliance management service downloads the bits for updating the agent platform to the desired version from the repository.

4. The method of claim 1, wherein the first agent is configured to manage a lifecycle of the cloud service agents and the pre-update check performed by the first agent includes a check on whether or not the first agent is processing any changes to the cloud service agents deployed on the agent platform appliance.

5. The method of claim 1, wherein the second agent is configured to manage communications with the management appliance and the pre-update check performed by the second agent includes a check on whether or not the second agent is processing any changes to the management appliances.

6. The method of claim 1, wherein the instruction to update the agent platform appliance to the desired version is issued by a cloud service for managing the agent platform appliance.

7. The method of claim 6, wherein another cloud service generates a list of agent platform appliances that need to be updated to the desired version, and the cloud service for managing the agent platform appliance issues instructions to update the agent platform appliances in the list to the desired version.

8. The method of claim 1, wherein the instruction to update the agent platform appliance to the desired version is issued internally by the agent platform appliance as a result of the agent platform appliance detecting that it has been disconnected from a cloud service for managing the agent platform appliance for longer than a threshold period of time.

9. A non-transitory computer readable medium comprising instructions to be executed in a computer system to carry out a method of updating an agent platform appliance in a customer environment on which cloud service agents are deployed to deliver cloud services to management appliances of a software-defined data center provisioned in the customer environment, said method comprising:
in response to an instruction to update the agent platform appliance to a desired version, (i) determining that a current version of the agent platform appliance does not match the desired version, (ii) determining connectivity to a repository that stores bits for updating the agent platform appliance to the desired version, and (iii) requesting a first agent of the cloud service agents to perform a first pre-update check and a second agent of the cloud service agents to perform a second pre-update check; and
after the first pre-update check and the second pre-update check have passed, requesting an appliance management service running on the agent platform appliance to perform an update of the agent platform appliance to the desired version.

10. The non-transitory computer readable medium of claim 9, wherein the method further comprises:
in response to the instruction to update the agent platform appliance to the desired version, determining that the agent platform appliance has sufficient computational resources to update the agent platform appliance to the desired version.

11. The non-transitory computer readable medium of claim 10, wherein the appliance management service downloads the bits for updating the agent platform appliance to the desired version from the repository.

12. The non-transitory computer readable medium of claim 9, wherein the first agent is configured to manage a lifecycle of the cloud service agents and the pre-update check performed by the first agent includes a check on whether or not the first agent is processing any changes to the cloud service agents deployed on the agent platform appliance.

13. The non-transitory computer readable medium of claim 9, wherein the second agent is configured to manage communications with the management appliance and the pre-update check performed by the second agent includes a check on whether or not the second agent is processing any changes to the management appliances.

14. The non-transitory computer readable medium of claim 9, wherein the cloud service agents further include a third agent that exchanges messages with a message broker cloud service and one of the messages includes the instruction to update the agent platform appliance to the desired version.

15. The non-transitory computer readable medium of claim 14, wherein the instruction to update the agent platform appliance to the desired version is issued by a cloud service for managing the agent platform appliance.

16. The non-transitory computer readable medium of claim 15, wherein another cloud service generates a list of agent platform appliances that need to be updated to the desired version, and the cloud service for managing the agent platform appliance issues instructions to update the agent platform appliances in the list to the desired version.

17. A computer system running in a customer environment and communicating with a cloud platform to update an agent platform appliance in the customer environment on which cloud service agents are deployed to deliver cloud services to management appliances of a software-defined data center provisioned in the customer environment, wherein the computer system is programmed to carry out the steps of:
in response to an instruction to update the agent platform appliance to a desired version, (i) determining that a current version of the agent platform appliance does not match the desired version, (ii) determining connectivity to a repository that stores bits for updating the agent platform appliance to the desired version, (iii) determining that the agent platform appliance has sufficient computational resources to update the agent platform appliance to the desired version, and (iv) requesting a first agent of the cloud service agents to perform a first pre-update check and a second agent of the cloud service agents to perform a second pre-update check; and
after the first pre-update check and the second pre-update check have passed, requesting an appliance management service running on the agent platform appliance to perform an update of the agent platform appliance to the desired version.

18. The computer system of claim 17, wherein the appliance management service downloads the bits for updating the agent platform appliance to the desired version from the repository.

19. The computer system of claim 17, wherein
the first agent is configured to manage a lifecycle of the cloud service agents and the pre-update check performed by the first agent includes a check on whether or not the first agent is processing any changes to the cloud service agents deployed on the agent platform appliance, and
the second agent is configured to manage communications with the management appliance and the pre-update check performed by the second agent includes a check on whether or not the second agent is processing any changes to the management appliances.

20. The computer system of claim 17, wherein
the cloud service agents further include a third agent that exchanges messages with a message broker cloud service and one of the messages includes the instruction to update the agent platform appliance to the desired version, and
the instruction to update the agent platform appliance to the desired version is issued by a cloud service for managing the agent platform appliance.
